(19) United States
(12) Patent Application Publication
(10) Pub. No.: US 2023/0138588 A1
(43) Pub. Date: May 4, 2023

(54) SERVER AND METHOD OF DETERMINING AN ADVANCED BOOKING FEE FOR AN ADVANCE BOOKING

(71) Applicant: GRABTAXI HOLDINGS PTE. LTD., Singapore (SG)

(72) Inventors: Wentong LI, Singapore (SG); Jialin LIU, Singapore (SG); Renrong WENG, Singapore (SG); Chun Kai PHANG, Singapore (SG)

(21) Appl. No.: 17/636,852

(22) PCT Filed: May 15, 2020
(86) PCT No.: PCT/SG2020/050283

§ 371 Date: Feb. 18, 2022

(51) Int. Cl. G06Q 30/02; G06Q 10/02; G06Q 50/30

(52) U.S. Cl. CPC G06Q 30/0283; G06Q 10/02; G06Q 50/30

(57) ABSTRACT

A server configured to determine an advanced booking fee for an advance booking is disclosed. The server may include one or more processor(s) and a memory having instructions stored therein. The instructions when executed by the one or more processor(s), may cause the one or more processor(s) to receive an advanced booking enquiry over a communication network from a user device for a predetermined transportation service at a predetermined future time from a service provider. The one or more processor(s) may determine a call option price based on a difference between a predetermined fare price of the advance booking and a potential future trip price. The one or more processor(s) may determine an earning adjustment for the service provider to provide the predetermined transportation service at the predetermined future time. The one or more processor(s) may determine the advanced booking fee for the predetermined transportation service at the predetermined future time based on the call option price and the earning adjustment.

### TECHNICAL FIELD

Various aspects of this disclosure relate to a method of determining an advanced booking fee for an advance booking. Various aspects of this disclosure relate to a server configured to determine an advanced booking fee for an advance booking. Various aspects of this disclosure relate to a non-transitory computer-readable medium storing computer executable code for determining an advanced booking fee for an advance booking. Various aspects of this disclosure relate to a computer executable code for determining an advanced booking fee for an advance booking.

### BACKGROUND

Advance Booking is a service that allows passengers to book a ride for their indicated time in the future. It is typically targeted at people who have confirmed travel needs during peak hours or people travelling from remote locations, in both cases on-demand allocation can be difficult.

For advance bookings, drivers receive a job broadcast for the advance booking earlier than the travel time and may reach passengers' locations early. To compensate for the additional waiting time, a booking fee is charged to the passenger for the advance booking.

Booking fee charged by the transportation companies is usually a fixed amount across the region to compensate the drivers for the additional service. However, it may not be justified to be as such, since occasionally passengers cancel at the last minute or drivers have to be kept from accepting other jobs for a rather long time.

### SUMMARY

Therefore, there may be a need to accurately price an advanced booking fee for an advance booking. There may also be a need to take into account the additional waiting time of drivers and/or cancellation of the advance booking by passengers when pricing an advanced booking fee for an advance booking to compensate the drivers for the additional service.

Various embodiments may provide a server configured to determine an advanced booking fee for an advance booking is disclosed. The server may include one or more processor(s) and a memory having instructions stored therein. The instructions when executed by the one or more processor(s), may cause the one or more processor(s) to receive an advanced booking enquiry over a communication network from a user device for a predetermined transportation service at a predetermined future time from a service provider. The one or more processor(s) may determine a call option price based on a difference between a predetermined fare price of the advance booking and a potential future trip price. The one or more processor(s) may determine an earning adjustment for the service provider to provide the predetermined transportation service at the predetermined future time. The one or more processor(s) may determine the advanced booking fee for the predetermined transportation service at the predetermined future time based on the call option price and the earning adjustment.

According to various embodiments, the call option price may be non-refundable and the earning adjustment may be refundable upon cancellation of the advance booking.

According to various embodiments, the predetermined fare price of the advance booking may be generated by the one or more processor(s) through regression of historical data of similar historical bookings stored in a database of the server.

According to various embodiments, the potential future trip price is determined by the one or more processor(s) through sampling of historical data of similar historical bookings with a higher price than the predetermined fare price of the advance booking.

According to various embodiments, the one or more processor(s) may be configured to determine a probability of the potential future trip price being higher than the predetermined fare price. Further, the one or more processor(s) may be configured to determine the call option price based on the difference between the predetermined fare price of the advance booking and the potential future trip price, and the probability.

According to various embodiments, the one or more processor(s) may be configured to determine a lock-in time before the predetermined future time in which the service provider will not be able to accept another booking.

According to various embodiments, the one or more processor(s) may be configured to determine potential geohashes of the service provider at the lock-in time based on a pick-up location of the advance booking. Further, the one or more processor(s) may be configured to determine surrounding geohashes of the potential geohashes of the service provider at the lock-in time.

According to various embodiments, the one or more processor(s) may be configured to determine an earning rate of the service provider for each surrounding geohashes at the lock-in time. Further, the one or more processor(s) may be configured to determine a probability of the service provider accepting a booking for each of the surrounding geohashes at the lock-in time.

According to various embodiments, the one or more processor(s) may be configured to determine the earning adjustment for the service provider to provide the predetermined transportation service at the predetermined future time based on the lock-in time, the earning rate for each surrounding geohashes, and the probability of the service provider accepting a booking for each of the surrounding geohashes.

Various embodiments may provide a method of determining an advanced booking fee for an advance booking. The method may include using one or more processor(s) of a server to receive an advanced booking enquiry over a communication network from a user device for a predetermined transportation service at a predetermined future time from a service provider. The one or more processor(s) may determine a call option price based on a difference between a predetermined fare price of the advance booking and a potential future trip price. The one or more processor(s) may determine an earning adjustment for the service provider to provide the predetermined transportation service at the predetermined future time. The one or more processor(s) may determine the advanced booking fee for the predetermined transportation service at the predetermined future time based on the call option price and the earning adjustment.

According to various embodiments, the call option price may be non-refundable and the earning adjustment may be refundable upon cancellation of the advance booking.

According to various embodiments, the method may include generating the predetermined fare price of the advance booking through regression of historical data of similar historical bookings stored in a database of the server.

According to various embodiments, the method may include determining the potential future trip price through sampling of historical data of similar historical bookings with a higher price than the predetermined fare price of the advance booking.

According to various embodiments, the method may include using the one or more processor(s) to determine a probability of the potential future trip price being higher than the predetermined fare price. Further, the method may include using the one or more processor(s) to determine the call option price based on the difference between the predetermined fare price of the advance booking and the potential future trip price, and the probability.

According to various embodiments, the method may include using the one or more processor(s) to determine a lock-in time before the predetermined future time in which the service provider will not be able to accept another booking.

According to various embodiments, the method may include using the one or more processor(s) to determine potential geohashes of the service provider at the lock-in time based on a pick-up location of the advance booking. Further, the method may include using the one or more processor(s) to determine surrounding geohashes of the potential geohashes of the service provider at the lock-in time.

According to various embodiments, the method may include using the one or more processor(s) to determine an earning rate of the service provider for each surrounding geohashes at the lock-in time. Further, the method may include using the one or more processor(s) to determine a probability of the service provider accepting a booking for each of the surrounding geohashes at the lock-in time.

According to various embodiments, the method may include using the one or more processor(s) to determine the earning adjustment for the service provider to provide the predetermined transportation service at the predetermined future time based on the lock-in time, the earning rate for each surrounding geohashes, and the probability of the service provider accepting a booking for each of the surrounding geohashes.

Various embodiments may provide a non-transitory computer-readable medium storing computer executable code comprising instructions for determining an advanced booking fee for an advance booking according to the various embodiments disclosed herein.

Various embodiments may provide a computer executable code comprising instructions for determining an advanced booking fee for an advance booking according to the various embodiments disclosed herein.

To the accomplishment of the foregoing and related ends, the one or more embodiments include the features hereinafter fully described and particularly pointed out in the claims. The following description and the associated drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The invention will be better understood with reference to the detailed description when considered in conjunction with the non-limiting examples and the accompanying drawings, in which:

FIG. 1 shows a flowchart of a method 200 according to various embodiments.

FIG. 2 shows a schematic diagram of a communication system 200 according to various embodiments.

FIG. 3 shows a chart 300 with historical probability of the potential future trip price being higher than the predetermined fare price in various geohashes according to various embodiments.

FIG. 4 shows a graph 400 for determining a lock-in time according to various embodiments.

It should be noted that like reference numbers are used to depict the same or similar elements, features, and structures throughout the drawings.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the systems or server or methods or computer program are analogously valid for the other systems or server or methods or computer program and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment or design described herein as “exemplary” is not necessarily to be construed as preferred or advantageous over other embodiments or designs

In the context of various embodiments, the articles “a”, “an”, and “the” as used with regard to a feature or element include a reference to one or more of the features or elements.

As used herein, the term “and/or” includes any and all combinations of one or more of the associated listed items.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

As used herein, the term “geohash” may be predefined geocoded cells of partitioned areas of a city or country.

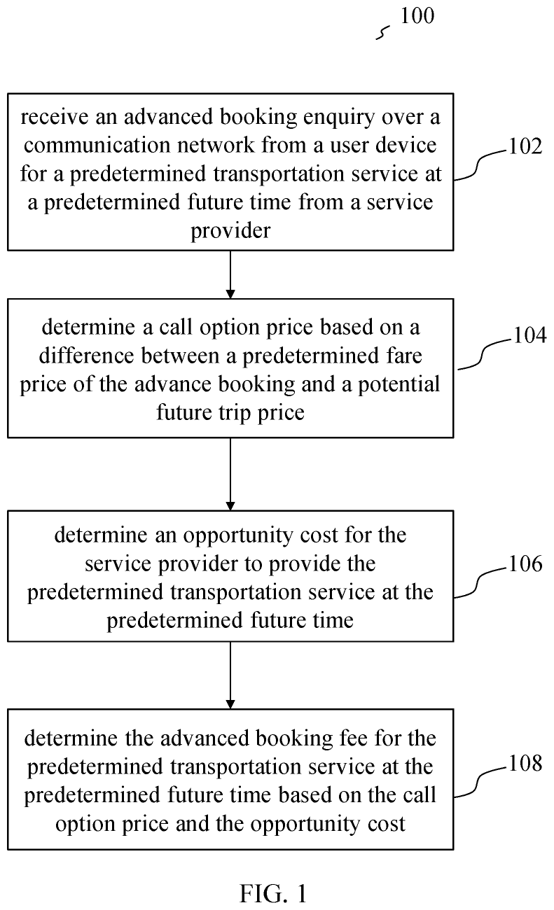

FIG. 1 shows a flowchart of a method 100 according to various embodiments.

According to various embodiments, the method 100 of determining an advanced booking fee for an advance booking may be provided. In some embodiments, the method 100 may include a step 102 of using one or more processor(s) of a server to receive an advanced booking enquiry over a communication network from a user device for a predetermined transportation service at a predetermined future time from a service provider. The method 100 may include a step 104 of using the one or more processor(s) to determine a call option price based on a difference between a predetermined fare price of the advance booking and a potential future trip price. The method 100 may include a step 106 of using the one or more processor(s) to determine an earning adjustment for the service provider to provide the predetermined transportation service at the predetermined future time. The method 100 may include a step 108 of using the one or more processor(s) to determine the advanced booking fee for the predetermined transportation service at the predetermined future time based on the call option price and the earning adjustment.

Steps 102 to 108 are shown in a specific order, however other arrangements are possible, for example, in some embodiments, step 104 may be carried out after step 106. Steps may also be combined in some cases. Any suitable order of steps 102 to 108 may be used.

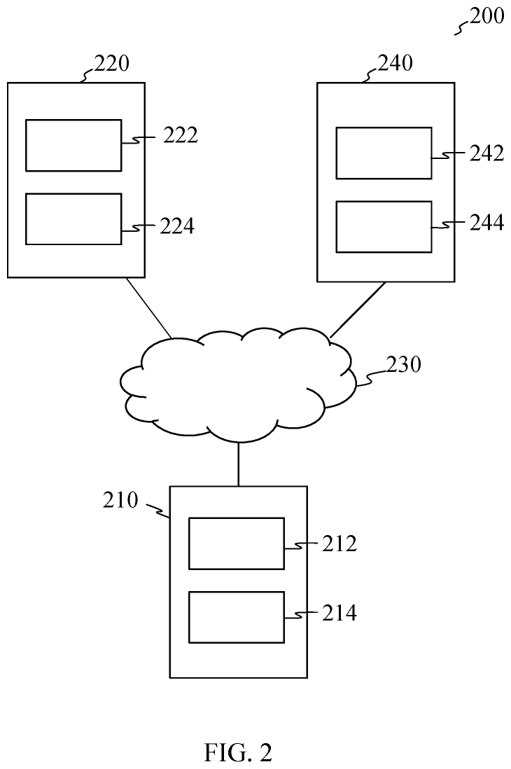

FIG. 2 shows a schematic diagram of a communication system 200 according to various embodiments.

According to various embodiments, the communication system 200 may include a server 210, and/or a user device 220 and/or a service provider device 240.

In some embodiments, the server 210 and the user device 220 may be in communication with each other through communication network 230. The server 210 and the service provider device 240 may also be in communication with each other through communication network 230. Even though FIG. 2 shows a line connecting the server 210 to the communication network 230, a line connecting the user device 220 to the communication network 230, and a line connecting the service provider device 240 to the communication network 230, the server 210, the user device 220, and the service provider device 240 may not be physically connected to each other, for example through a cable. Instead, the server 210, the user device 220, and the service provider device 240 may be able to communicate wirelessly through communication network 230 by internet communication protocols or through a mobile cellular communication network.

In various embodiments, the server 210 may be a single server as illustrated schematically in FIG. 2, or have the functionality performed by the server 210 distributed across multiple server components. The server 210 may include one or more server processor(s) 212. The various functions performed by the server 210 may be carried out by the one or more server processor(s). In some embodiments, the various functions performed by the server 210 may be carried out across the one or more server processor(s). In other embodiments, each specific function of the various functions performed by the server 210 may be carried out by specific server processor(s) of the one or more server processor(s).

In some embodiments, the server 210 may include a memory 214. The server 210 may also include a database. The memory 214 and the database may be one component or may be separate components. The memory 214 of the server may include computer executable code defining the functionality that the server 210 carries out under control of the one or more server processor 212. The database and/or memory 214 may include historical data of past transportation service, e.g., a pick-up location and/or drop-off location, and/or fare price, and/or booking fee and/or time. The memory 214 may include or may be a computer program product such as a non-transitory computer-readable medium.

According to various embodiments, a computer program product may store the computer executable code including instructions for determining an advanced booking fee for an advance booking according to the various embodiments. The computer executable code may be a computer program. The computer program product may be a non-transitory computer-readable medium. The computer program product may be in the communication system 100 and/or the server 210.

In some embodiments, the server 210 may also include an input and/or output module allowing the server 210 to communicate over the communication network 230. The server 210 may also include a user interface for user control of the server 210. The user interface may include, for example, computing peripheral devices such as display monitors, user input devices, for example, touchscreen devices and computer keyboards.

In various embodiments, the user device 220 may include a user device memory 222 and a user device processor 224. The user device memory 222 may include computer executable code defining the functionality the user device 220 carries out under control of the user device processor 224. The user device memory 222 may include or may be a computer program product such as a non-transitory computer-readable medium. The user device 220 may also include an input and/or output module allowing the user device 220 to communicate over the communication network 230. The user device 220 may also include a user interface for the user to control the user device 220. The user interface may be a touch panel display. The user interface may include a display monitor, a keyboard or buttons.

In various embodiments, the service provider device 240 may include a service provider device memory 242 and a service provider device processor 244. The service provider device memory 242 may include computer executable code defining the functionality the service provider device 240 carries out under control of the service provider device processor 244. The service provider device memory 242 may include or may be a computer program product such as a non-transitory computer-readable medium. The service provider device 240 may also include an input and/or output module allowing the service provider device 240 to communicate over the communication network 230. The service provider device 240 may also include a user interface for the user to control the service provider device 240. The user interface may be a touch panel display. The user interface may include a display monitor, a keyboard or buttons.

In various embodiments, the server 210 may be configured to determine an advanced booking fee for an advance booking. In some embodiments, the server 210 may receive an advanced booking enquiry over the communication network 230 from the user device 220 for a predetermined transportation service at a predetermined future time from a service provider.

In various embodiments, the server 210 may determine the advanced booking fee for the predetermined transportation service at the predetermined future time based on the call option price and the earning adjustment.

In some embodiments, the server 210 may determine the advanced booking fee for the advance booking using a formula:

B_{T}min(max(F_{T}+E_{T},B_{L}),B_{U})

wherein B_{T} represents the advanced booking fee charged for the advance booking which is going to take place at predetermined future time T, F_{T} represents the call option price, E_{T} represents an earning adjustment for the service provider to provide the predetermined transportation service at the predetermined future time, B_{L} represents a lower bound of the advanced booking fee and B_{U} represents an upper bound of the advanced booking fee.

In some embodiments, since there may be variables, e.g., the call option price F_{T} and/or earning adjustment E_{T} which may not be known during the advanced booking enquiry, an estimate of the advanced booking fee may be computed instead using the formula:

\hat{B}_{T}=min(max(\hat{F}_{T}+Ê_{T},B_{L}),B_{U})

wherein \hat{B}_{T} represents an estimate of the advanced booking fee charged for the advance booking which is going to take place at predetermined future time T, \hat{F}_{T} represents an estimate of the call option price, Ê_{T} represents an estimate of the earning adjustment for the service provider to provide the predetermined transportation service at the predetermined future time, B_{L} represents a lower bound of the advanced booking fee and B_{U} represents an upper bound of the advanced booking fee.

It shall be appreciated that the term “advanced booking fee” will cover the term “estimate of the advanced booking fee”, the term “call option price” will cover the term “estimate of the call option price”, and the term “earning adjustment” will cover the term “estimate of the earning adjustment”.

In some embodiments, the lower bound B_{L} of the advanced booking fee may be the minimum advanced booking fee. The upper bound B_{U} of the advanced booking fee may be the maximum advanced booking fee. The lower bound B_{L} and/or the upper bound B_{U} of the advanced booking fee may be predetermined values.

In some embodiments, the server 210 may determine the advanced booking fee for the advance booking based on the call option price F_{T} and/or earning adjustment E_{T}. For example, the server 210 may determine the advanced booking fee based on a summation of the call option price F_{T} and earning adjustment E_{T}. In some embodiments, if the summation of the call option price F_{T} and the earning adjustment E_{T} is lower than the lower bound B_{L}, the server may determine that the advanced booking fee is the lower bound B_{L}. In other embodiments, if the summation of the call option price F_{T} and the earning adjustment E_{T} is higher than the upper bound B_{U}, the server may determine that the advanced booking fee is the upper bound B_{U}. In other embodiments, if the summation of the call option price F_{T} and the earning adjustment E_{T} is between the lower bound B_{L}, and the upper bound B_{U}, the server may determine that the advanced booking fee is the summation of the call option price F_{T} and the earning adjustment E_{T}.

In various embodiments, the call option price may be non-refundable and/or the earning adjustment may be refundable upon cancellation of the advance booking. In other embodiments, when the advanced booking fee is the lower bound B_{L}, or the upper bound B_{U}, a portion of call option price may be non-refundable and/or a portion of the earning adjustment may be refundable upon cancellation of the advance booking. The portion of the earning adjustment may be refundable may be obtained based on a ratio of the earning adjustment and the call option price.

In various embodiments, the server may determine the call option price F_{T} based on a European call option. A European call option may be a contract that limits execution to its maturity time T. For example, assuming that a user makes an advanced booking at booking time T₀ for a predetermined transportation service at a predetermined future time T, which is the scheduled pick up time, the user can only exercise the call option and take the predetermined transportation service at the predetermined future time T. The user may indicate a predetermined pick-up location and a predetermined drop-off location when making the advanced booking and/or when making an advanced booking enquiry to check advanced booking fee prices and a predetermined fare price K for the predetermined pick-up location and the predetermined drop-off location.

In some embodiments, the server may determine the call option price F_{T} based on the predetermined fare price K of the advanced booking and a potential future trip price S_{T}. The predetermined fare price K may be the fare guarantee price of the predetermined transportation service with the predetermined pick-up location at the predetermined future time T and the predetermined drop-off location. The predetermined fare price K may be communicated to the user when the user makes the advanced booking enquiry. The potential future trip price S_{T} may be a potential price of a trip from the predetermined pick-up location at the predetermined future time T and the predetermined drop-off location. The potential future trip price S_{T} may be a strike price.

In some embodiments, at the predetermined future time T, the potential future trip price S_{T} may be different from the predetermined fare price K since the predetermined fare price K was determined at booking time T₀. The difference may be caused by potential surge in demand and/or lack of service provider and/or traffic conditions and/or other factors at the predetermined future time T which may be hard to predict at the booking time T₀.

For example, the user may make an advanced booking on a Monday at 10 am for a predetermined transportation service with a predetermined pick-up location and a predetermined drop-off location on Wednesday at 2 μm. The server may communicate to the user that the predetermined fare price K for taking the predetermined transportation service is $10. On Wednesday at 2 pm, the server may determine that based on the current surge in demand and/or lack of service provider and/or traffic conditions, the potential future trip price S_{T} is $15. However, since the user has already made an advanced booking, the price the user has to pay for the predetermined transportation service is still the predetermined fare price K of $10.

In some embodiments, the server may determine the call option price F_{T} based on a difference between a predetermined fare price of the advance booking and a potential future trip price.

In some embodiments, when the potential future trip price S_{T} is higher than K, by exercising the call option, and taking the advanced booking at the cost of the predetermined fare price K, the passenger may get a payoff of:

(S_{T}−K)⁺=max{K,0}

Therefore, the user may have an expected payoff which may be a benefit from the predetermined fare price K. The expected payoff may be used as the call option price F_{T}, where F_{T}=F(S_{T}, T₀, T) as follows:

F(S_{T},T₀,T) [symbol] (S_{T}−K|S_{T}≥K [symbol] (S_{T}≥K)

wherein [symbol] [S_{T}−K|S_{T}≥K] is the payoff when the potential future trip price S_{T} is higher than K and [symbol] (S_{T}≥K) is the probability of the potential future trip price S_{T} being higher than K.

In some embodiments, Black-Scholes partial differential equation may be used to solve for S_{T} if follows log normal distribution, that is,

$$\frac{\partial f}{\partial t} + rS \frac{\partial f}{\partial S} + \frac{1}{2} {σ}^{2} {S}^{2} \frac{{\partial }^{2} f}{\partial {S}^{2}} - rf = 0$$

In some embodiments, the user may cancel the advanced booking, for example, if the user finds a cheaper on-demand fare at the predetermined future time T. Without the call option fee, making an advance booking may produce a non-negative expected payoff, which may be known as arbitrage. In some embodiments, the system may aim to eliminate arbitrage by imposing the call option price as part of the advanced booking fee. The call option price may also be seen as a cancellation fee which may be a latent option price that may be sold to the user at the time of the advanced booking.

In various embodiments, the predetermined fare price K may be determined by the server 210 through regression, e.g., quantile regression. In various embodiments, the server 210 may include a quantile regression neural network. The quantile regression neural network may be trained. The quantile regression neural network may be a feedforward neural network with quantile regression loss. A quantile may be a value below which a fraction of observations in a group falls. For example, a prediction for a quantile of 0.9 should over-predict 90% of the times. Regression based on quantile loss may provide sensible prediction intervals even for variables with non-constant variance or non-normal distribution, which may be suitable to predict surges or fare prices.

In various embodiments, the server 210 may provide the predetermined fare price K, for example, calculated based on a pre-defined quantile (e.g., at 95%), which may then be used for fare prediction. The quantile may be the probability of the predetermined fare price K being higher than the potential future trip price S_{T}. The predetermined fare price of the advance booking may be generated by the one or more processor(s) 212 through regression of historical data of similar historical bookings stored in a database or in the memory 214 of the server 210. Similar historical bookings may be historical bookings with pick-up locations in a same geohash or surrounding geohashes as the predetermined pick-up location, and/or historical bookings with drop-off locations in a same geohash or surrounding geohashes as the predetermined drop-off location.

In some embodiments, the predetermined fare price K may be determined by:

K=Quantile_{α}(S_{T})=inf(S_{T}: [symbol] (S_{T}≤K)≤α%}

where α is the probability of the predetermined fare price K being higher than the potential future trip price S_{T}. The probability α may be set to a predetermined value, e.g., 95%. In some embodiments, P(S_{T}≤K) may be reversely calculated to obtain P(S_{T}≥K) which may be (100-α)%.

In some embodiments, the call option price F_{T} may be obtained by:

$${F}_{T} = ( {S}_{T} - K ) + ( 1 - \frac{α}{100} )$$

wherein (S_{T}−K)⁺ may the difference between a predetermined fare price of the advance booking and a potential future trip price, and

$$( 1 - \frac{α}{100} )$$

may be the probability of the potential future trip price S_{T} being higher than K.

In various embodiments, the potential future trip price S_{T} may be determined by the one or more processor(s) 212 through sampling of historical data of similar historical bookings with a higher price than the predetermined fare price K of the advance booking. Similar historical bookings may be historical bookings with pick-up locations in a same geohash or surrounding geohashes as the predetermined pick-up location, and/or historical bookings with drop-off locations in a same geohash or surrounding geohashes as the predetermined drop-off location.

In some embodiments, the potential future trip price S_{T} may be determined through naïve sampling of historical data of similar historical bookings with a higher price than the predetermined fare price K of the advance booking. The naïve sampling of historical data of similar historical bookings may be the average of historical data of similar historical bookings with a higher price than the predetermined fare price K of the advance booking as follows:

$$\hat{{S}_{T}} = {\sum }_{n = 1 , … , N} \frac{{S}_{n}}{N} , {S}_{n} \geq K$$

Since S_{T}>K may be a rare event, simulation efficiency may be low. Therefore, more efficient and/or effective sampling methods may be used instead.

In some embodiments, the potential future trip price S_{T} may be determined through Importance Sampling of historical data of similar historical bookings with a higher price than the predetermined fare price K of the advance booking. The Importance Sampling may utilise a nonlinear transformation g(S_{T}) such that [symbol] (g(S_{T})≥g(K))>> [symbol] (S_{T}≥K).

For instance, we may assume S_{T} follows approximately a Normal Distribution, then the exponential transformation exp(S_{T}) follows approximately a Log Normal distribution that may have a higher density on the right tail. Hence, it may be easier to sample exp(Sₙ) with a higher efficiency. Subsequently, we may apply an inverse operation to reveal Sₙ=ln[exp(Sₙ)] and may obtain the improved estimate as follows:

$$\hat{{S}_{T}} = {\sum }_{n = 1 , … , N} \frac{{g}^{- 1} [ g ( {S}_{n} ) ]}{N} , g ( {S}_{n} ) \geq f ( K )$$

In some embodiments, the potential future trip price S_{T} may be determined through Splitting Algorithm of historical data of similar historical bookings with a higher price than the predetermined fare price K of the advance booking. The Splitting Algorithm may construct a sequence of barriers K₁< . . . <Kᵢ . . . <K and may iteratively sample from new conditional distributions with a significant chance to hit the next barrier. The potential future trip price S_{T} may be determined by collecting the samples and assembling them.

In various embodiments, the one or more processor(s) 212 may be configured to determine a probability of the potential future trip price being higher than the predetermined fare price.

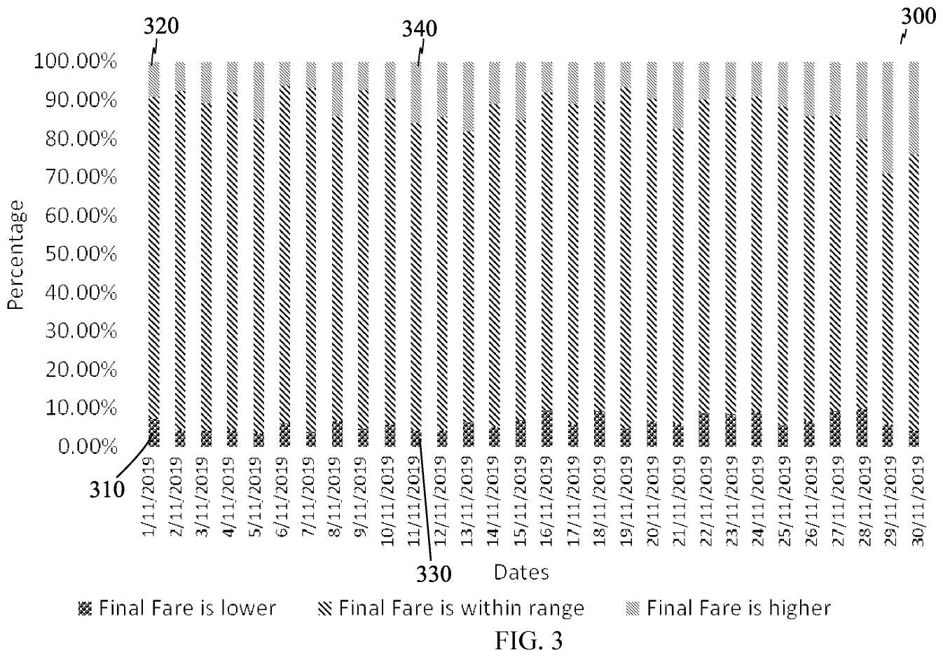

FIG. 3 shows a chart 300 with historical probability of the potential future trip price being higher than the predetermined fare price in various geohashes according to various embodiments.

In various embodiments, due to various reasons in reality, e.g., under and/or over estimate of travel distance and/or duration, observations of (100-α)% may not always be a fixed predetermined value. e.g., 5%. For example, as shown in FIG. 3, for geohash 310, the probability 320 of the potential future trip price being higher than the predetermined fare price is 9%. In another example, as shown in FIG. 3, for geohash 330, the probability 340 of the potential future trip price being higher than the predetermined fare price is 17%.

In some embodiments, the average of observations may be used as a bias correction to generate a new estimate \hat{α}.

In some embodiments, the one or more processor(s) 212 may be configured to determine the call option price based on the difference between the predetermined fare price of the advance booking and the potential future trip price, and the probability as follows:

$$\hat{{F}_{T}} = ( \hat{{S}_{T}} - K ) + ( 1 - \frac{α}{100} )$$

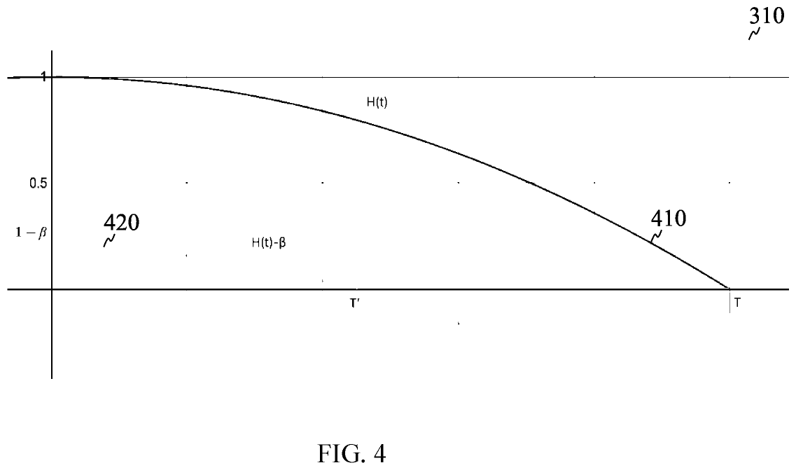

FIG. 4 shows a graph 400 for determining a lock-in time according to various embodiments.

In various embodiments, the one or more processor(s) 212 may be configured to determine a lock-in time T′ before the predetermined future time T in which the service provider 240 will not be able to accept another booking.

In some embodiments, to ensure best allocation of ride, the service provider 240 may be prevented from accepting any other rides from lock-in time T′. To compensate for driver waiting time and potential loss of rides, an earning adjustment from T′ to T may be added to the advanced booking fee. In some embodiments, a monotonic decreasing function allocation probability with respect to T′ may be introduced. The monotonic decreasing function allocation probability may be:

[symbol]

(allocation_{T′}_{ᵢ})≤ [symbol] (allocation_{T′}_{ⱼ}),∀T>T′ᵢ≥T′ⱼ

In some embodiments, this may mean that for a later lock-in time T′, the probability of allocation will not be higher than an earlier lock-in time T′.

In some embodiments, upon the advanced booking enquiry, the latest value of T′ may be estimated by:

sup{T′: [symbol] (allocation_{T′})≥β}

where β is the target allocation rate set that may be predetermined.

In some embodiments, the allocation time may be as close to booking time as possible, e.g., 5 minutes, as the longer the lock-in period, the higher the compensation paid to the service provider

In some embodiments, an auxiliary function may be defined as

H(t)= [symbol] (allocationₜ)−β

In the graph 400 shown in FIG. 4, the x-axis of graph 400 may represent time, and the y-axis of graph 400 may represent probability of allocation.

In some embodiments, a bisection root search method may be used to search for the lock-in time T′. Based on historical data, H(T−τ)≈1−β may be plotted. Assuming the allocation algorithm is static, the possible root among data points t that T−τ≤t≤T may be obtained. Curve 410 representing H(t) and curve 420 representing H(t)−β may be plotted. After iteration stops, H(T−τ₁)≥0 and H(T−τ₂)≤0 may be obtained, and the root which represents the lock-in time T′=T−τ₁ may be obtained.

In various embodiments, the one or more processor(s) 212 may be configured to determine potential geohashes of the service provider at the lock-in time based on the pick-up location of the advance booking. In some embodiments, the potential geohashes that the service provider may be at the lock-in time may be determined by a predetermined distance threshold from the pick-up location of the advance booking. In other embodiments, the potential geohashes that the service provider may be at the lock-in time may be determined by a predetermined time threshold, wherein the service provider is able to get to the pick-up location from the potential geohashes within the predetermined time threshold.

In some embodiments, the one or more processor(s) 212 may be configured to determine surrounding geohashes of the potential geohashes of the service provider at the lock-in time.

In various embodiments, the one or more processor(s) 212 may be configured to determine the earning adjustment for the service provider to provide the predetermined transportation service at the predetermined future time based on the lock-in time, the earning rate for each surrounding geohashes, and the probability of the service provider accepting a booking for each of the surrounding geohashes.

In some embodiments, the earning adjustment may be obtained as a summation of latent fares for rides in the surrounding geohashes that the service provider may accept if the service provider did not accept the advance booking, weighed by the probability of the driver being in each geohash g′:

$$\begin{matrix}{E}_{T} = 𝔼 [ {e}_{{T}^{′}} \vert {g}_{{T}^{′}} ] [ {g}_{{T}^{′}} ] \\ = {\sum }_{{g}_{T}^{′} ∈ G} ( {e}_{{T}^{′}} \vert {g}_{{T}^{′}} ) [ {g}_{{T}^{′}} ] \\ = {\sum }_{{g}_{T}^{′} ∈ G} ( {e}_{{T}^{′}}^{u} Δ t \vert {g}_{{T}^{′}} ) [ {g}_{{T}^{′}} ]\end{matrix}$$

where e_{T}^{u}, is the estimated job earning per minute at timestamp T′ had the driver accepted an available on-demand job, a Δt is the time span of interval [T′,T], which is Δt=T′−T, g′ is the geohash areas and [symbol] [g_{T′}] is the probability of the driver being in each geohash g′.

In some embodiments, the earning adjustment E_{T} may make the expected opportunity cost of not accepting another job in nearby geohashes at time T′ close to zero. In other words, expected on-demand fare that may be forgone by the service provider by waiting until the predetermined future time T may be close to or equal to the earning adjustment given in the advance booking fee. Thus, the service provider may choose either options.

In various embodiments, the one or more processor(s) 212 may be configured to determine an earning rate of the service provider for each surrounding geohashes at the lock-in time. In some embodiments, the one or more processor(s) 212 may be configured to determine a probability of the service provider accepting a booking for each of the surrounding geohashes at the lock-in time.

In various embodiments, for each pick-up location, the server 210 is configured to determine a set of geohashes G including surrounding geohashes of the pick-up location. The set of geohashes G may also include the geohash in which pick-up location is located in. The number of geohashes in the set G may be denoted by dim G and may be predetermined by the server 210. In some embodiments, the service provider may be in any of the geohashes in set G at lock-in time T′. Since the broadcasting range of the server 210 to potential service providers is usually within a small neighbourhood, dim G may any suitable number to cover the small neighbourhood, e.g., less than 20 geohashes.

In some embodiments, a forecasting algorithm, e.g., a long term driver acceptance forecasting algorithm, on historical Advance Bookings of similar characteristics may be trained to obtain the probability P[gT′]. In other embodiments, sampling, such as simple sampling or Monte Carlo sampling on historical Advance Bookings of similar characteristics may be conducted to obtain the probability P[gT′].

In some embodiments, by assuming surge applies in each geohash, e_{T′}^{u}|g_{T′}∝surge_{T′}|g_{T′}, surge and fare forecasting algorithms may be used to gain an estimate of earning efficiency e_{T}^{û}, for each gT′.

In various embodiments, the surge may be configured as a feedback control problem, and control theory may be applied to generate a surge value automatically using the real-time and/or historical supply/demand information. The supply information may be characterized by the occupancy rate which defines the percentage of service providers who are occupied and the demand information may be characterized by the allocation rate which indicates the percentage of customers who get allocated. The server may be configured to generate the surge such that the allocation rate and occupancy rate are controlled at a target level. As such, the majority of service providers may be able to receive service orders while the majority of customers can be allocated.

In an exemplary embodiment, a high level description of the pricing unit configuration based on a “control problem approach” is provided. Provided a discrete market model (city level or geohash level) as

Pₜ₊₁=f(Pₜ,sₜ)

with Sₜ as the surge value of the price for a transportation service at time period t, Pₜ=[P_{allocation}; P_{occupancy}] a vector consisting of allocation rate of service orders 106 and occupancy rate of drivers 104 with specified initial conditions as Pₜ_{₀}=[P_{allocation,t}_{₀}; P_{occupancy,t}_{₀}]

In some embodiments, the following cost function may be minimized:

U=Σₜ₌ₜ_{₀}^{t=ind}(Pₜ−P_{target})^{T}Q(Pₜ−P_{target})

where Q is a positive definite weight matrix. Thus, the server may be configured to determine sₜ₊₁=g(Pₜ) which can minimize the cost function U. As an example, for each predetermined area, for example, having the same geohash code, the server may provide real-time supply/demand signals as well as smoothed (e.g. by a moving average) supply/demand signals.

For example, Dₜ, Dₜ^{smooth}, Sₜ, Sₜ^{smooth} may denote the demand, smoothed demand, supply and smoothed supply at time period t, respectively. Each of these signals may be further decomposed into two parts: met signal and unmet signal, that is

Dₜ=Dₜ^{met}+Dₜ^{unmet}

Sₜ=Sₜ^{met}+Sₜ^{unmet}

Dₜ^{smooth}=Dₜ^{smoothed_met}+Dₜ^{smoothed_unmet}

Sₜ^{smooth}=Sₜ^{smoothed_met}+Sₜ^{smoothed_unmet}

From these signals, a first signal and a second signal may be derived. The first signal may be the allocation rate represented by yₜ^{a} and the second signal may be occupancy rate represented by yₜ^{o}:

$${y}_{t}^{a} = \frac{{D}_{t}^{smoothed \_ met}}{{D}_{t}^{smoothed \_ met} + {D}_{t}^{smoothed \_ unmet}} = \frac{{D}_{t}^{smoothed \_ met}}{{D}_{t}^{smooth}}$$

$${y}_{t}^{o} = \frac{{S}_{t}^{smoothed \_ met}}{{S}_{t}^{smoothed \_ met} + {S}_{t}^{smoothed \_ unmet}} = \frac{{S}_{t}^{smoothed \_ met}}{{S}_{t}^{smooth}}$$

Here, sₜ may denote the surge value applied on the price for a transportation service for a predetermined area (e.g. having the same geohash code) at time period t. The surge function algorithm aims to configure sₜ such that yₜ^{a} and yₜ^{o} follow y_{d}^{a} and y_{d}^{a} as closely as possible. Here, y_{d}^{a} and y_{d}^{a} denote a desired or intended allocation rate and occupancy rate, respectively.

In various embodiments, the server may use fare forecasting algorithms to gain an estimate of earning efficiency e_{T}^{û}, for each gT′. The server may include a long term surge predictor (LTSP) and a short term surge predictor (STSP). In some embodiments, the long term surge predictor (LTSP) may calculate a long term surge prediction based historical data. The short term surge predictor (STSP) may calculate a short term surge prediction based on recent data. The recent data being more recent than the historical data used by the long term surge predictor (LTSP). the server may be configured to calculate a forecasted fare based on the lock-in time T′ and one or both of: the long term surge prediction and the short term surge prediction.

While the invention has been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A server configured to determine an advanced booking fee for an advance booking, the server comprising:
one or more processor(s); and
a memory having instructions stored therein, the instructions, when executed by the one or more processor(s), cause the one or more processor(s) to:
receive an advanced booking enquiry over a communication network from a user device for a predetermined transportation service at a predetermined future time from a service provider;
determine a call option price based on a difference between a predetermined fare price of the advance booking and a potential future trip price;
determine an earning adjustment for the service provider to provide the predetermined transportation service at the predetermined future time; and
determine the advanced booking fee for the predetermined transportation service at the predetermined future time based on the call option price and the earning adjustment, wherein the call option price is non-refundable and the earning adjustment is refundable upon cancellation of the advance booking.

2. The server of claim 1, wherein the predetermined fare price of the advance booking is generated by the one or more processor(s) through regression of historical data of similar historical bookings stored in a database of the server.

3. The server of claim 1, wherein the potential future trip price is determined by the one or more processor(s) through sampling of historical data of similar historical bookings with a higher price than the predetermined fare price of the advance booking.

4. The server of claim 1,
wherein the one or more processor(s) is configured to:
determine a probability of the potential future trip price being higher than the predetermined fare price; and
determine the call option price based on the difference between the predetermined fare price of the advance booking and the potential future trip price, and the probability.

5. The server of claim 1, wherein the one or more processor(s) is configured to determine a lock-in time before the predetermined future time in which the service provider will not be able to accept another booking.

6. The server of claim 5, wherein the one or more processor(s) is configured to:
determine potential geohashes of the service provider at the lock-in time based on a pick-up location of the advance booking; and
determine surrounding geohashes of the potential geohashes of the service provider at the lock-in time.

7. The server of claim 6, wherein the one or more processor(s) is configured to:
determine an earning rate of the service provider for each surrounding geohashes at the lock-in time; and
determine a probability of the service provider accepting a booking for each of the surrounding geohashes at the lock-in time.

8. The server of claim 7, wherein the one or more processor(s) is configured to:
determine the earning adjustment for the service provider to provide the predetermined transportation service at the predetermined future time based on the lock-in time, the earning rate for each surrounding geohashes, and the probability of the service provider accepting a booking for each of the surrounding geohashes.

9. A method of determining an advanced booking fee for an advance booking comprising
using one or more processor(s) of a server to:
receive an advanced booking enquiry over a communication network from a user device for a predetermined transportation service at a predetermined future time from a service provider;
determine a call option price based on a difference between a predetermined fare price of the advance booking and a potential future trip price;
determine an earning adjustment for the service provider to provide the predetermined transportation service at the predetermined future time; and
determine the advanced booking fee for the predetermined transportation service at the predetermined future time based on the call option price and the earning adjustment, wherein the call option price is non-refundable and the earning adjustment is refundable upon cancellation of the advance booking.

10. The method of claim 9, further comprising:
generating the predetermined fare price of the advance booking through regression of historical data of similar historical bookings stored in a database of the server.

11. The method of claim 9, further comprising:
determining the potential future trip price through sampling of historical data of similar historical bookings with a higher price than the predetermined fare price of the advance booking.

12. The method of claim 9, further comprising using the one or more processor(s) to:
determine a probability of the potential future trip price being higher than the predetermined fare price; and
determine the call option price based on the difference between the predetermined fare price of the advance booking and the potential future trip price, and the probability.

13. The method of claim 9, further comprising using the one or more processor(s) to:
determine a lock-in time before the predetermined future time in which the service provider will not be able to accept another booking.

14. The method of claim 13, further comprising using the one or more processor(s) to:
determine potential geohashes of the service provider at the lock-in time based on a pick-up location of the advance booking; and
determine surrounding geohashes of the potential geohashes of the service provider at the lock-in time.

15. The method of claim 14, further comprising using the one or more processor(s) to:
determine an earning rate of the service provider for each surrounding geohashes at the lock-in time; and
determine a probability of the service provider accepting a booking for each of the surrounding geohashes at the lock-in time.

16. The method of claim 15, further comprising using the one or more processor(s) to:
determine the earning adjustment for the service provider to provide the predetermined transportation service at the predetermined future time based on the lock-in time, the earning rate for each surrounding geohashes, and the probability of the service provider accepting a booking for each of the surrounding geohashes.

17-20. (canceled)
